(19) United States
(12) Patent Application Publication
(10) Pub. No.: US 2015/0003828 A1
(43) Pub. Date: Jan. 1, 2015

(54) Digital Fiber Link Transporting Multiple Analog Bands for Agile Conversion

(71) Applicant: Cable Television Laboratories, Inc., Louisville, CO (US)

(72) Inventors: Thomas H. Williams, Longmont, CO (US); Luis Alberto Campos, Superior, CO (US); Christopher Donley, Broomfield, CO (US)

(21) Appl. No.: 13/931,528

(22) Filed: Jun. 28, 2013

(51) Int. Cl. H04L 12/761; H04B 10/2575; H04L 12/741

(52) U.S. Cl. CPC H04L 45/16; H04L 45/74; H04B 10/2575
USPC 398/45; 398/115

(57) ABSTRACT

A digital (fiber optic) link transports one or more RF digital signal blocks, that when converted into analog and (optionally) converted to a RF center frequency with an D-A converter, form RF analog signal blocks. The RF analog signal block occupies a specified frequency band and is preferably capable of being distributed over a downstream coaxial portion of a HFC network and/or being broadcast. The D-A conversion is performed in a fiber node at a remote location where the transmission medium converts from digital optical fiber preferably to coaxial cable. The multiple RF digital signal blocks may be broadcast to multiple nodes or unicast to a single node. The RF signal blocks allow for any type of band-limited RF signal to be transported. The optical digital traffic to compose a RF analog signal blocks using a D-A converter may be point-to-point Ethernet, or may utilize a software-defined networking controller such as the one described in the OpenFlow™ specification, and may use buffering as necessary.

### BACKGROUND OF THE INVENTION

This invention relates in general to the transport of multiple signal bands, and in particular to transporting multiple signal bands for agile conversion using a digital optical link.

Transmission systems convey information from a source location to endpoints in a network. Because of the technical advantages of fiber optic cable, including low loss and high information-carrying capacity, fiber optic cables are used for the long-distance transport of signals. However, coaxial cable is superior for distributing signals in a tree-and-branch architecture due to ease of splitting, combining, and termination, such as at the back of a television set, or into cable modem. Coaxial cable has a limited RF bandwidth due to high attenuation, which also reduces signal to noise ratio. Limited RF bandwidth and low signal-to-noise limits information-carrying capacity, as described by Shannon's Theorem.

Coaxial cable is able to transport multiple different frequencies simultaneously, and this is called “frequency division multiplexing”. Optical cable is also capable of transporting multiple different frequencies (a.k.a wavelengths) simultaneously, but this requires expensive optical filtering to separate the wavelengths, using either coarse wavelength division multiplexing or dense wavelength division multiplexing (DWDM). However, due to the exceedingly high data capacity of fiber optic cables (e.g. 100 Gbits/sec) time division multiplexing is both effective and low cost when using a single wavelength.

Modern cable distribution systems compose wideband signals at a headend (this term may be used interchangeably with ‘hub’ site) using an edge-QAM, as described in CableLabs publication CM-SP-EQAM-VSI-I01-081107. The edge-QAMs receive a high speed Ethernet input using the DEPI interface standard. The edge-QAMs output a composite analog RF signal composed of many (e.g. 24) 6 MHz wide QAM signals, according to the DRFI output interface standard. The 6 MHz wide signals may be Internet signals from a CMTS (cable modem termination system) or digital video signals for STBs. Thus the output of an edge-QAM device is a wide composite analog signal block comprised of multiple 6 MHz wide digital carriers using different RF frequencies. In Europe, the digital carriers are typically 8 MHz wide.

These wide signal blocks are combined with other signals at other radio frequencies and connected to an analog laser for delivery to nodes. Analog lasers suffer the disadvantages of background noise, limited range, high cost, and non-linearity, and a need for cooling. Non-linearity implies that light output is not proportional to current input. A fiber optic cable delivers the signal from the headend to a plurality of fiber nodes. The optic signal may be split and amplified using erbium-doped fiber amplifiers.

At a fiber node, the analog optic light signal is converted to an analog electrical signal, typically with a frequency range (in the USA) of 54 to 860 MHz. This analog electrical signal is applied to a tree and branch network which employs splitters and amplifiers to deliver the signal to multiple terminal devices. Upstream signals in the 5-42 MHz frequency range travel upstream to provide 2-way communications to the terminal devices, which may be cable modems (CMs), set top boxes (STBs), gateway devices, or multimedia terminal devices. Fiber nodes typically deliver signals to between 100 and 500 homes passed, but the number of homes in a node has been dropping as new nodes are created by node splitting. Fiber nodes are typically die-cast housing in a pedestal or mounted on a strand connected to a telephone pole. Alternately, they may be in a cabinet indoors for large multiple-dwelling complexes.

The analog optic link, as mentioned earlier, has weaknesses of high cost, noise addition, and non-linearity, and a proposed solution is to essentially place the edge-QAM functionality out in the fiber node and deliver information using a digital laser. The advantage of doing this is that the fiber delivery of bits is efficient, but a price paid is future flexibility. That is, should the type of modulations handled by the edge-QAM change, all of the nodes in a network need to be visited and upgraded with next-generation equipment. For example, should there be a need opportunity to deliver wireless signals in the future all the remote nodes need to be upgraded. Other disadvantages of placing edge-QAMs in nodes are their physical size, need for cooling, power consumption, and vulnerability to temperature swings, difficulty troubleshooting, and condensing humidity.

Cable networks in the past have been “fat dumb pipes”, which means the wide RF bandwidth is agnostic and transports any type of RF signal, such as analog television, FM radio, 256-QAM, OFDM, or anything that can be invented in the future. This would end if edge-QAMs were placed in the fiber nodes.

Another weakness of the analog optic links is the need, for cost reasons, to use a common signal for many subscribers that are in different nodes. That is, signal sharing limit available bandwidth. There may be data traffic in one node that is being consumed by subscribers in another node. This need to share bandwidth limits the available bandwidth to all nodes.

### SUMMARY OF THE INVENTION

One embodiment is directed to a transmission system which comprises a circuit constructing a digital electrical signal stream that includes digital signal blocks directed to different fiber nodes connected to terminals belonging to different user groups. The digital signal blocks are directed to at least one of the fiber nodes and carry information that is different from the information carried by digital signal blocks directed to the remaining fiber nodes. A digital laser responds to said digital electrical signal stream and sends digital optical signals to said different fiber nodes through optical paths.

Another embodiment is directed to a receiver system located at a fiber node receiving digital optical signals. The receiver system comprises an optical to electrical converter converting the digital optical signals into digital signal blocks and a plurality of converters, each of the converters converting selected ones of said digital signal blocks into baseband samples, and then into digital signal blocks at selected RF frequencies. A summer combines the digital signal blocks at selected RF frequencies into a digital stream and a D/A converter converting the digital stream into analog signal blocks of the selected RF frequencies.

Yet another embodiment is directed to a receiver system that comprises a plurality of subsystems receiving digital optical signals, each subsystem located at a corresponding fiber node of a plurality of fiber nodes. Each of the subsystems comprises an optical to electrical converter converting the digital optical signals into digital signal blocks, a plurality of converters, each of the converters converting selected ones of said digital signal blocks into baseband samples, and then into digital signal blocks at selected RF frequencies. A summer combines the digital signal blocks at selected RF frequencies into a digital stream, and a D/A converter converts the digital stream into analog signal blocks of the selected RF frequencies. A selected first RF frequency of digital signal blocks converted by one of the converters in a first one of the subsystems located at a corresponding fiber node is different from a selected second RF frequency of digital signal blocks from one of the converters in a second one of the subsystems located at a corresponding different fiber node and different from the first one of the subsystems.

Still one more embodiment is directed to a combination of the transmission system described above, and a receiver system that comprises a plurality of subsystems described above.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a block diagram of headend signal origination using an analog optic link to illustrate a conventional system.

FIG. 2 is a block diagram of improved headend signal origination using a digital optic link to illustrate one embodiment of the invention.

FIG. 3 is a block diagram of a fiber node and coaxial distribution system to illustrate an embodiment of the invention.

FIGS. 4A and 4B are spectral diagrams of two different signals supplied to two different downstream service groups useful for illustrate an embodiment of the invention.

FIG. 5 is a block diagram illustrating the routing of Ethernet frames from the transmission system to the receiver system using a software-defined networking device such as an OpenFlow™ controller.

Identical components are labeled by the same numerals in this document.

### DETAILED DESCRIPTION OF EXEMPLARY EMBODIMENTS

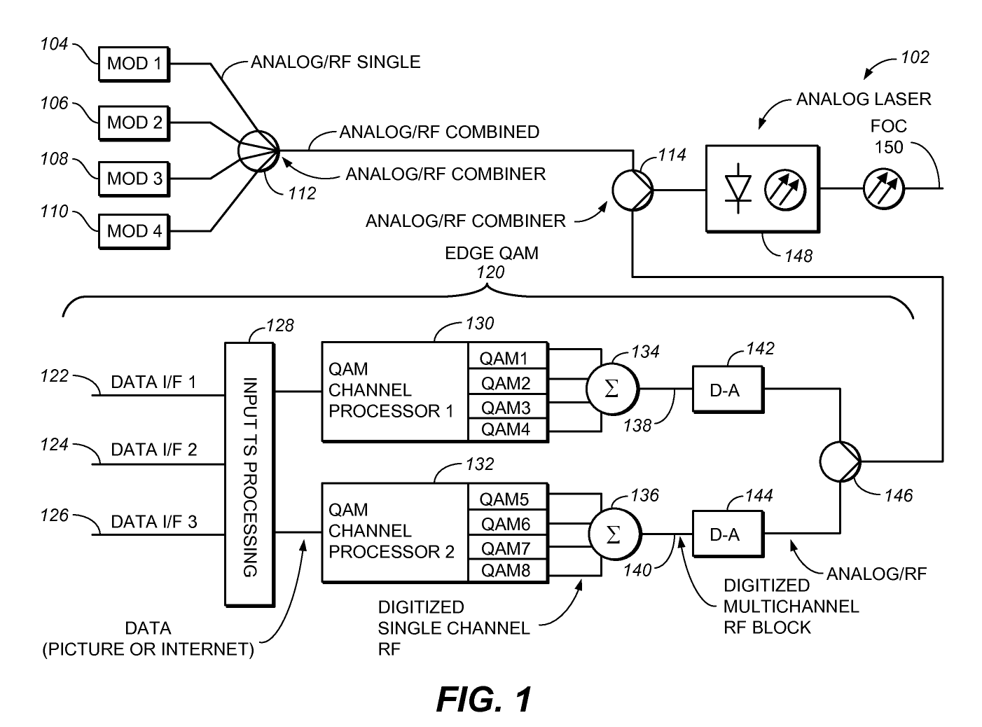

FIG. 1 is a block diagram of system 102 of signal processing that occurs in current Cable headends to illustrate a conventional system. Example frequencies are given for United States systems, but comparable numbers apply elsewhere in the world. Legacy 6 MHz analog television channels are produced by analog NTSC modulators 104, 106, 108, and 110. These modulators input analog baseband video and audio and produce RF outputs, such as RF Channel 2 with a picture carrier at 55.25 MHz. Several modulators' signals are combined by RF combiner 112 to produce an analog block of video carriers, such as RF channels 2, 3, 4, and 5 which occupy 24 MHz. With time, the number of analog TV carriers is decreasing and the number of digital carrier, transporting both video entertainment and Internet data, is increasing. In some systems analog carriers have already been eliminated.

The digital channels, also occupying 6 MHz each, are created by an edgeQAM or EQAM 120. Operation of edgeQAMs are specified in CableLabs specification CM-SP-EQAM-VSI-I01-081107.pdf. The function of an edgeQAM is to take in data as information bits, which may be picture, audio or Internet information, and output one or more composite RF digital signal blocks comprised of multiple digital carriers, each occupying 6 MHz.

The data interfaces (I/F) 122, 124 and 126 are typically Ethernet connections to either a program source, video servers, or a CMTS for Internet connectivity. Input transport stream processing 128 selects which MPEG pictures are applied to which RF carriers. Video pictures may be standard or high definition, and may be broadcast (sent to all terminals in a service group), unicast (sent to only one terminal) or multicast (sent to multiple terminals while at least one of the terminals requests the information). Internet data is also applied to the input data I/F.

Because of different interleaving requirements (for burst noise protection) Internet data and video pictures are not carried on a same 6 MHz wide carrier. QAM channel processors 130 and 132 take data (picture, Internet, or both) from the input TS processing block 128 and create multiple QAM channels; 4 each are illustrated for QAM channel processor one 130 and QAM channel processor two 132. The multiplexes of 4 digitized single channel RF modulated signals are combined in digital summers 134 and 136 to produce multichannel 24 MHz-wide RF digital signal blocks on lines 138 and 140. D-A converters 142 and 144 convert the digital multichannel RF blocks to 24 MHz wide RF analog signal blocks. Note that many more bits/sec flow out of each QAM channel processor than flow into them as information bits. This is because the QAM modulation process involves filtering, which increased the number of bits/second.

RF combiner 146 combines the 24 MHz wide blocks from D-A converters 142 and 144. RF combiner 114 combines the signals from RF combiner 146 and RF combiner 112 and applies the output to analog laser transmitter 148 which launces an analog optic signal onto fiber optic cable (FOC) 150. The analog optic signal forms a downstream service group which goes to multiple nodes (not shown). Multiple nodes are sometimes fed from one analog laser for cost considerations. The analog optic signal from laser transmitter 148 can be split and amplified as required. The analog laser transmitter also adds random noise, non-linearity, and typically the laser requires cooling.

In the fiber nodes the downstream analog optic signal is converted to an analog electrical signal and distributed to terminals in homes.

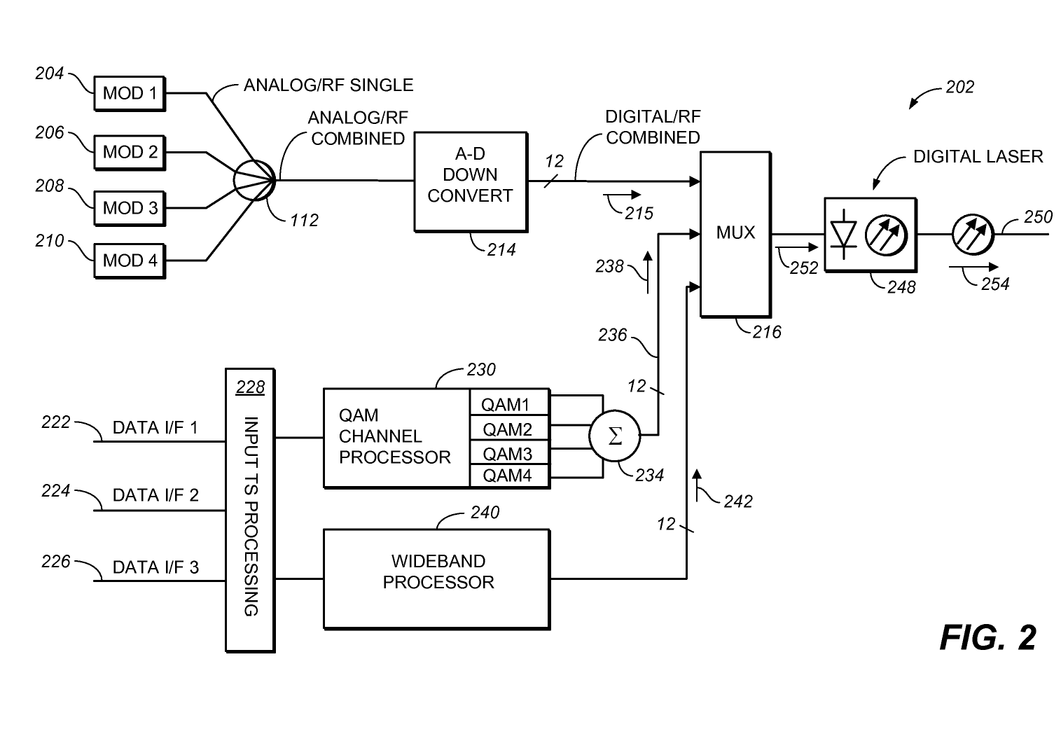

### Description of FIG. 2

FIG. 2 is a block diagram of the headend transmitter portion to illustrate one embodiment of the present invention. It includes NTSC modulators 204, 206, 208, and 210. The analog/RF outputs of the modulators are combined by RF combiner 212. The combiner 212 produces an analog signal block of video carriers which are digitized by A-D converter/down-converter 214. The block 214 converts the analog signal block to digital samples and then digitally down-converts the block to a baseband block of carriers using 10-12 bits of resolution per sample, forming a RF digital signal block 215. The digital down-conversion process is known in the art and may use techniques such as subsampling. The output is a high-speed digital stream with digital samples above the Nyquist rate for the band, which would be greater than 48 MegaSamples/sec for 24 MHz of RF bandwidth.

A multiplexer 216 receives the serial stream from A-D converter/downconverter 214, multiplexes this baseband frequency block with other baseband frequency blocks, such as blocks 238 and 242 described below, and applies its output to digital laser 248. Digital laser 248 transmits a high-speed serial stream of bits on downstream fiber optic cable 250. The multiplexer 216 will include buffering, and may also encode the blocks to frames, such as Ethernet frames. An Ethernet frame contains a MAC address that specifies the destination of the frame. If data formats other than Ethernet are used for the digital signal blocks, such formats also include destination addresses for routing the blocks.

EdgeQAM functionality is accomplished by data interfaces 222, 224, and 226 applied to input TS processor 228. The selected data for QAM channel processor 230 is converted into a first QAM signal block outputted on line 236 as a RF digital signal block 238. In a preferred embodiment the QAM modulator in 230 would center the digital signal block 238 at 0 Hz. The first RF digital signal block is a high-speed 12 bit serial stream which is applied to multiplexer 216 with buffering.

A wideband processor 240 inputs Internet data and converts it to a RF digital signal block 242 centered at 0 Hz. This block 242 is also applied to multiplexer 216, which multiplexes streams 238 and 242 with stream 215.

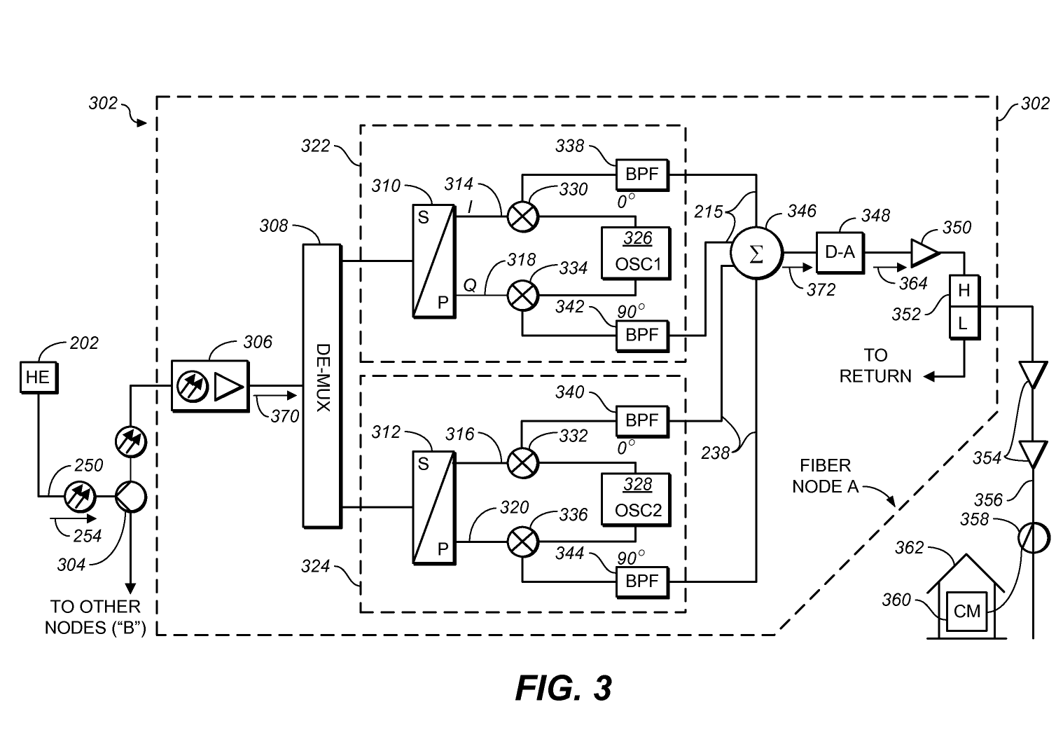

FIG. 3 is a block diagram of subsystem 302 of receiver elements in a fiber node “A”. Fiber node “B” is equipped with a subsystem (not shown) of receiver elements similar to those of subsystem 302. While only two subsystems at nodes “A”, “B” are shown in FIG. 3, more subsystems similar to subsystem 302 may be included at other nodes (not shown) and are within the scope of the invention. The optical digital signals from the headend block diagram 202 of FIG. 2 arrive on digital fiber optic cable 250. The optical signal in the fiber optic cable may have been split by splitter 304 and/or amplified prior to reception by optical to electrical converter 306. The signal in the fiber optic cable can also be distributed to another node “B”. The high-speed digital stream of digital signal blocks, which may be 40 to 100 Gbits/sec, is connected to de-multiplexer 308. The de-multiplexer 308 reads the destination addresses of the received data, such as MAC addresses, (in the case of Ethernet frames) and directs the frames to the appropriate converter 322 or 324 using the destination addresses. The de-multiplexer 308 supplies serial stream on a time-division multiplex basis to two block up-converters 322 and 324. Block up-converters 322, 324 convert serial streams of RF digital signal blocks to baseband digital I (in-phase) and Q (quadrature) samples, and then convert the baseband digital samples to digital signal blocks at RF frequencies. Serial-parallel converters 310 and 312 receive the data from the de-multiplexer 308. The parallel outputs of each serial-parallel converter may each consists of 24 bits, with 12 bits for each of I signals 314 and 316 and 12 bits for each of Q signals 318 and 320. Up-conversion is accomplished by complex digital modulators comprised of local oscillators 326 and 328 supplying signals of different reference frequencies. Each local oscillator is a numerically-controlled oscillator (NCO) with a 0 degree output and a 90 degree output. Other elements in the digital up-converters are digital mixers 330, 332, 334, and 336, and digital bandpass filters 338, 340, 342, and 344. Digital up-converters are known in the art. Both sets of I and Q up-converted outputs are applied to digital summer 346, and then to D-A, converter 348. While only two converters 322, 324 are shown in FIG. 3, it will be understood that more converters may be included in each of the subsystems such as 302 at nodes “A” and “B”; these variations are within the scope of the invention.

D-A converter 348 uses a sampling rate sufficient for the Nyquist criteria, so a 1000 MHz RF signal 364 would require a sample rate of around 2.5 GSamples/sec. It is assumed that a lowpass filter element is internal to D-A 348 to remove aliased frequencies. Amplifier 350 boosts the RF signal and diplex filter 352 separates upstream signals from downstream signals. Amplifiers 354 boost the signal in coaxial cable 356, and tap 358 extracts some of the downstream RF signal to operate a receiver in Cable Modem (CM) 360 in house 362.

D-A converter 348 creates a composite downstream signal with low background noise and low distortion. Downstream RF signal 364, in this example, is comprised of RF analog signal blocks. One block may be broadcast or multicast mode signals that are used by multiple nodes and the other could consist of unicast mode signals consumed by only one node.

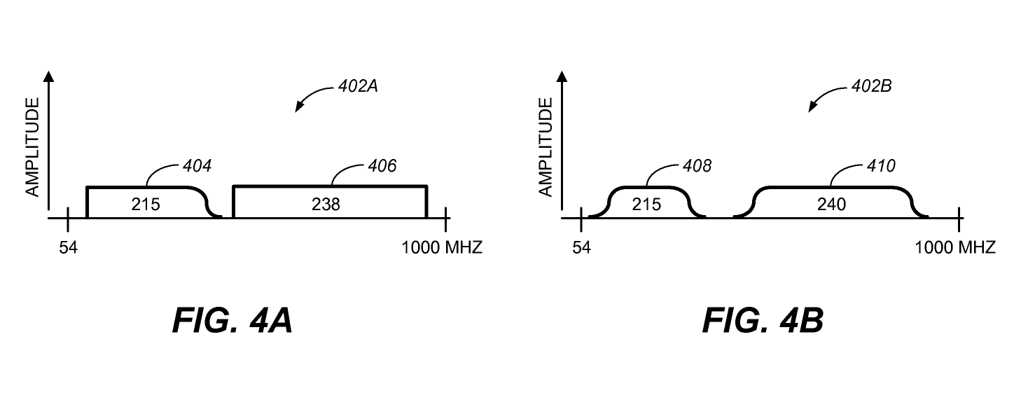

### Description FIG. 4A and FIG. 4B

FIG. 4A is a spectral diagram 402A of amplitude vs. frequency for fiber node A and FIG. 4B is a spectral diagram 402B for fiber node B. Two RF analog signal blocks are illustrated for node A that were generated from streams 215, and 238 in the transmission system 202 of FIG. 2, and two RF signal blocks for node B that were generated from streams 215 and 240 in system 202. Center frequencies 404 and 406 were determined by the different frequencies of oscillators 326 and 328. Block center frequencies 408 and 410 were determined by frequencies of oscillators in fiber node B, similar to fiber node A, but not illustrated. Note that RF signal block center frequencies in one node need not be the same RF signal block center frequencies in another node, even for the same RF analog signal block. This feature would be useful to avoid interference from strong interferers, such as from FM radio broadcasts, broadcast TV stations, or LTE (long term evolution cell phone) transmit towers, that might afflict one geographical area, but not another. For example, the center frequencies 404 and 408 at nodes A and B respectively may be different even though both were generated from stream 215.

In one implementation, stream 215 carries broadcast mode signals, and streams 238 and 242 carry unicast signals or multicast signals of different information content, so that these streams 238 and 242 deliver different information to the two nodes A and B. While two nodes A and B are illustrated in FIG. 3, obviously more nodes may be included to receive the optical signals from splitter 304 if desired. While blocks 215, 238 and 242 may advantageously be at baseband in some applications, for certain applications such as unicast streams, one or more may be at RF frequencies, so that such digital signal block or blocks do not need to be up converted at the nodes. In this case the up-converter function could be eliminated or use a frequency of 0 Hz.

In the embodiment of FIG. 3, all of the nodes receive the same optical signals. Note that by supplying different RF digital signal blocks to different nodes, different service groups are created. This allows each node to have more bandwidth for the signals that will be consumed in that node. Alternatively, lower RF bandwidth reduces amplifier loading and improves distortion performance.

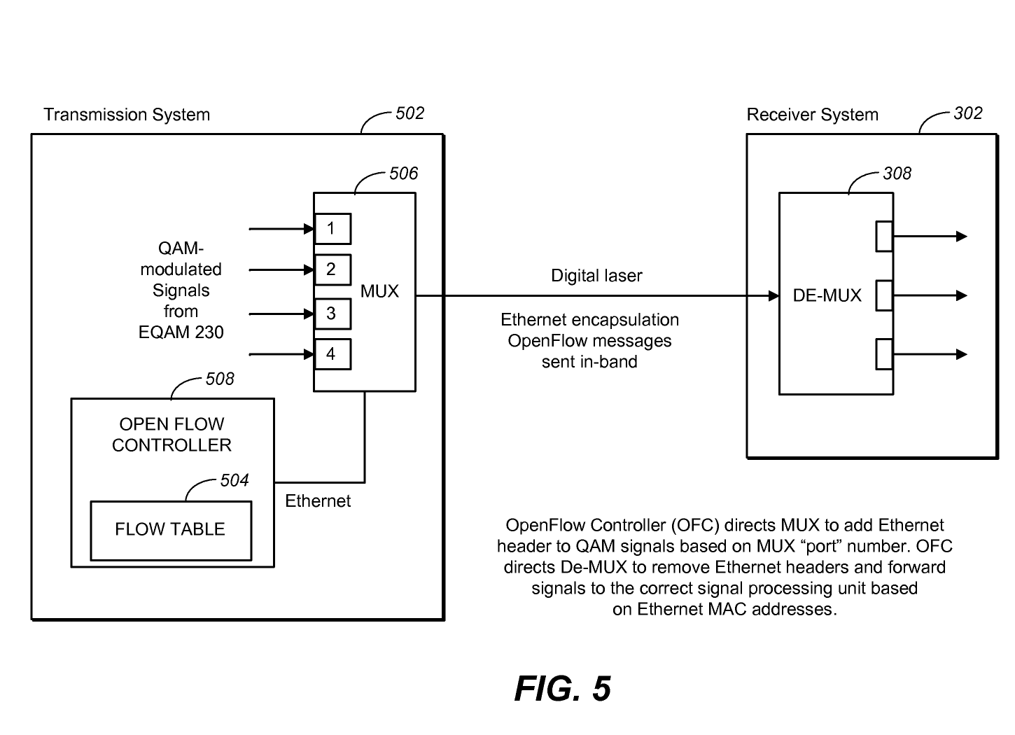

### Description of FIG. 5.

In another embodiment, the routing of the Ethernet frames from the transmission system to the receiver system may be accomplished using a software-defined networking device such as an OpenFlow™ controller. This is illustrated in FIG. 5, which is a block diagram of a portion of a transmission system 502 and a portion of a receiver system 302, where other components of the transmission and receiver systems are omitted to simplify the figure. The four output signals of EQAM 230 of FIG. 2 may be supplied to a multiplexer 506 in transmission system 502 controlled by an OpenFlow™ controller 508, which directs the multiplexer 506 to add Ethernet headers to the EQAM modulated output signals, to build Ethernet frames. Based on the port number of multiplexer 506 stored in flow table 504, controller 508 also causes flow table 504 to provide messages containing instructions for the de-multiplexer 308 in receiver system 302 of FIG. 3. The instructions will direct the de-multiplexer 308 to remove the Ethernet headers from the Ethernet frames and forward the load in the frames to the appropriate and correct converters in receiver system 302 based on the MAC addresses in the Ethernet headers. For detailed information of the operation of the OpenFlow™ controller 508, please see the OpenFlow™ Switch Specification, Version 1.3.0 (Wire Protocol 0x04), Jun. 25, 2012 by the OPEN NETWORKING FOUNDATION.

Analog signal blocks may have a frequency separation between them, or the frequency separation may be zero.

Signal blocks may also be used to insert pilot signals (used for amplifier AGC control) and diagnostic test signals, such as leakage detection signals that technicians receive in the field to locate the sources of signal egress or leakage.

Because the digital signal blocks are added (or combined), it is also possible for one signal block to have an intentional spectral hole inserted into its spectrum that another signal block fills with other content, such as pilot signals or diagnostic test signals. For details of how this may be accomplished, please see U.S. patent application Ser. No. 13/841,313, filed Mar. 15, 2013, entitled “ORTHOGONAL SIGNAL DEMODULATION.”

Bandpass filters 338, 340, 342, and 344 are programmable to pass the entire digital signal block that they are filtering. However, it is also possible for these bandpass filters to limit transmitted spectrum or create spectral holes. This technique would be useful to limit amplifier RF loading, or to accommodate nodes that have a lower frequency capability. For example, some amplifiers have an upper frequency limit of 750 MHz and other amplifiers in the same node on another branch have 1000 MHz capability.

Although the various aspects of the present invention have been described with respect to certain preferred embodiments, it is understood that the invention is entitled to protection within the full scope of the appended claims.

What is claimed is:

1. A transmission system comprising:
a circuit constructing a digital electrical signal stream that includes digital signal blocks directed to different fiber nodes connected to terminals belonging to different user groups, wherein the digital signal blocks directed to at least one of said fiber nodes carry information that is different from the information carried by digital signal blocks directed to the remaining fiber nodes; and
a digital laser responsive to said digital electrical signal stream and sending digital optical signals to said different fiber nodes through optical paths.

2. The system of claim 1, wherein digital signal blocks directed to each one of the fiber nodes comprise a stream of Ethernet frames with a destination address, and the destination addresses of the Ethernet frames directed to different ones of the fiber nodes are different.

3. The system of claim 1, wherein digital signal blocks directed to each one of the fiber nodes comprise a stream of Ethernet frames and messages regarding replacement of headers of the Ethernet frames by information regarding which of the fiber nodes is destination of the Ethernet frames.

4. The system of claim 3, further comprising a software-defined networking controller containing a flow table that provides instruction on stripping headers from a stream of Ethernet frames and embed said messages in the Ethernet frames.

5. The system of claim 1, wherein said digital electrical signal stream is at baseband.

6. The system of claim 1, wherein at least some of the digital signal blocks in said digital electrical signal stream are not at baseband.

7. The system of claim 1, wherein at least some of said digital signal blocks in the digital electrical signal stream were derived from a plurality of analog RF signal blocks.

8. The system of claim 7, further comprising one or more analog modulators providing one or more analog RF signal blocks, and an AD converter converting said plurality of analog RF signal blocks to said at least some of said digital signal blocks.

9. The system of claim 8, wherein said AD converter down converts said plurality of analog RF signal blocks to said at least some of said digital signal blocks at baseband.

10. The system of claim 1, said circuit including at least one wide band processor that creates a digital bit stream.

11. The system of claim 10, said at least one wide band processor including at least one EQAM.

12. The system of claim 1, wherein said digital electrical signal stream includes broadcast mode signals directed to all of the fiber nodes and unicast or multicast mode signals directed to an individual one or ones of the different fiber nodes.

13. A receiver system located at a fiber node receiving digital optical signals, comprising:
an optical to electrical converter converting the digital optical signals into digital signal blocks;
a plurality of converters, each of the converters converting selected ones of said digital signal blocks into baseband samples, and then into digital signal blocks at selected RF frequencies;
a summer combining said digital signal blocks at selected RF frequencies into a digital stream; and
a D/A converter converting said digital stream into analog signal blocks of said selected RF frequencies.

14. The receiver system of claim 13, each of said plurality of converters having a destination address, wherein said digital signal blocks are associated with different destination addresses, and each of said plurality of converters converting only digital signal blocks associated with the destination address of such converter into digital signal blocks at selected RF frequencies.

15. The receiver system of claim 14, further comprising a demultiplexer that directs the digital signal blocks to each of the plurality of converters based on the destination addresses associated with said digital signal blocks.

16. The receiver system of claim 13, wherein at least two of said plurality of converters convert selected ones of said digital signal blocks into digital signal blocks at two different RF frequencies

17. The receiver system of claim 13, wherein said digital signal blocks convey Ethernet frames with instructions for removing headers of the Ethernet frames and information regarding which of the plurality of converters is to convert the Ethernet frames, said system further comprising a demultiplexer that responds to said instructions by removing headers of the Ethernet frames and directing the Ethernet frames to one of the converters according to said information.

18. The receiver system of claim 13, each of the converters converting selected ones of said digital signal blocks into baseband digital I (in-phase) and Q (quadrature) samples.

19. A receiver system comprising a plurality of subsystems receiving digital optical signals, each subsystem located at a corresponding fiber node of a plurality of fiber nodes, each of said subsystems comprising:
an optical to electrical converter converting the digital optical signals into digital signal blocks;
a plurality of converters, each of the converters converting selected ones of said digital signal blocks into baseband samples, and then into digital signal blocks at selected RF frequencies;
a summer combining said digital signal blocks at selected RF frequencies into a digital stream; and
a D/A converter converting said digital stream into analog signal blocks of said selected RF frequencies, wherein a selected first RF frequency of digital signal blocks converted by one of the converters in a first one of the subsystems located at a corresponding fiber node is different from a selected second RF frequency of digital signal blocks converted by one of the converters in a second one of the subsystems located at a corresponding different fiber node and different from the first one of the subsystems.

20. The receiver system of claim 19, the optical to electrical converter of each of the subsystems converts the digital optical signals into digital signal blocks at baseband.

21. The receiver system of claim 19, wherein said digital signal blocks of said selected first and second RF frequencies are unicast or multicast mode signals.

22. The receiver system of claim 19, wherein digital signal blocks processed by at least two of the subsystems comprise broadcast or multicast mode signals carrying the same information and such digital signal blocks have substantially the same RF frequency.

23. The receiver system of claim 19, wherein digital signal blocks processed by at least two of the subsystems comprise broadcast or multicast mode signals carrying the same information and such digital signal blocks have different RF frequencies.

24. The receiver system of claim 19, each of the converters in each of the subsystems converting selected ones of said digital signal blocks into baseband digital I (in-phase) and Q (quadrature) samples.

25. A transmission and receiver system comprising:
(a) a transmission system comprising:
a circuit constructing a digital electrical signal stream that includes digital signal blocks directed to different fiber nodes connected to terminals belonging to different corresponding user groups, wherein the digital signal blocks directed to at least one of said fiber nodes carry information that is different from the information carried by digital signal blocks directed to the remaining fiber nodes; and
a digital laser responsive to said digital electrical signal stream and sending digital optical signals to said different fiber nodes through optical paths; and
(b) a plurality of subsystems, each subsystem located at one of a plurality of fiber nodes receiving at least some of the digital optical signals, each of said subsystems comprising:
an optical to electrical converter converting the digital optical signals into digital signal blocks;
a plurality of converters, each of the converters converting selected ones of said digital signal blocks into baseband samples, and then into digital signal blocks at selected RF frequencies;
a summer combining said digital signal blocks at selected RF frequencies into a digital stream; and
a D/A converter converting said digital stream into analog signal blocks of said selected RF frequencies, wherein a selected first RF frequency of digital signal blocks converted by one of the converters in a first one of the subsystems located at a corresponding fiber node is different from a selected second RF frequency of digital signal blocks converted by one of the converters in a second one of the subsystems located at a corresponding different fiber node and different from the first one of the subsystems.

26. The transmission and receiver system of claim 25, the optical to electrical converter of each of the subsystems converts the digital optical signals into digital signal blocks at baseband.

27. The transmission and receiver system of claim 25, wherein said digital signal blocks of said selected first and second RF frequencies are unicast or multicast mode signals.

28. The transmission and receiver system of claim 25, wherein digital signal blocks processed by at least two of the subsystems comprise broadcast or multicast mode signals carrying the same information and such digital signal blocks have substantially the same RF frequency.

29. The transmission and receiver system of claim 25, wherein digital signal blocks processed by at least two of the subsystems comprise broadcast or multicast mode signals carrying the same information and such digital signal blocks processed by said at least two of the subsystems have different RF frequencies.

30. The receiver system of claim 25, each of the converters in each of the subsystems converting selected ones of said digital signal blocks into baseband digital I (in-phase) and Q (quadrature) samples.
